(19) United States
(12) Patent Application Publication
(10) Pub. No.: US 2020/0342385 A1
(43) Pub. Date: Oct. 29, 2020

(54) PRODUCING A RANKING FOR A FARMER

(71) Applicant: International Business Machines Corporation, Armonk, NY (US)

(72) Inventors: Aanchal Goyal, Patparganj (IN); Ranjini Bangalore Guruprasad, Bangalore (IN); Sambaran Bandyopadhyay, West Bengal (IN); Sachin Gupta, Costa Del Sol (SG)

(21) Appl. No.: 16/392,326

(22) Filed: Apr. 23, 2019

(51) Int. Cl. G06Q 10/06; G06N 20/00

(52) U.S. Cl. CPC G06Q 10/06393; G06N 20/00; G06Q 10/06398

(57) ABSTRACT

One embodiment provides a method, including: identifying a target farmer having a farm producing a crop; receiving at least one target farmer input related to at least one of: (i) a growing condition of the crop of the target farmer and (ii) a characteristic of the crop; receiving, from each of the plurality of other farmers, additional input; validating the at least one target farmer input by comparing the at least one target farmer input to the additional inputs; generating a reliability score for the target farmer; and producing a ranking for the target farmer with respect to the plurality of other farmers.

### BACKGROUND

Farmers grow and provide food products, for example, produce, grain, meat, and the like. While the farmers are growing and/or producing the food products, many events could occur that can change the quality of the food product. For example, environmental conditions (e.g., drought, extra rain, rain during a particular growth period, bug infestation, etc.) may change the quality of the food product. In order to identify the impact of any growing conditions on the quality of the food product, many stakeholders (e.g., insurance companies, pesticide companies, banks, food product retail stores, etc.) rely on information provided by the farmer themselves. For example, the farmer may indicate that the crop was affected by a drought. The information provided by the farmer may be difficult to verify because growing conditions can be different within a regional area and the farmer can take different actions that affect the food product quality.

### BRIEF SUMMARY

In summary, one aspect of the invention provides a method, comprising: identifying a target farmer having a farm producing a crop, wherein the target farmer is located in the same geographical region as a plurality of other farmers each of whom has a farm producing the crop; receiving, from the target farmer, at least one target farmer input related to at least one of: (i) a growing condition of the crop corresponding to the farm of the target farmer and (ii) a characteristic of the crop produced by the target farmer; receiving, from each of the plurality of other farmers, additional input related to at least one of: (i) a growing condition of the crop corresponding to the farm of the other farmer and (ii) a characteristic of the crop produced by the other farmer; validating the at least one target farmer input by comparing it to the additional inputs from the plurality of other farmers; generating, from the validation, a reliability score for the target farmer by performing at least one of: (i) increasing the reliability score when the at least one target farmer input matches at least a majority of the at least one other farmer inputs and (ii) decreasing the reliability score when the at least one target farmer input does not match at least a majority of the at least one other farmer inputs; and producing, from the reliability score, a ranking for the target farmer with respect to the plurality of other farmers.

Another aspect of the invention provides an apparatus, comprising: at least one processor; and computer readable storage medium having computer readable program code embodied therewith and executable by the at least one processor, the computer readable program code comprising: computer readable program code configured to identify a target farmer having a farm producing a crop, wherein the target farmer is located in the same geographical region as a plurality of other farmers each of whom has a farm producing the crop; computer readable program code configured to receive, from the target farmer, at least one target farmer input related to at least one of: (i) a growing condition of the crop corresponding to the farm of the target farmer and (ii) a characteristic of the crop produced by the target farmer; computer readable program code configured to receive, from each of the plurality of other farmers, additional input related to at least one of: (i) a growing condition of the crop corresponding to the farm of the other farmer and (ii) a characteristic of the crop produced by the other farmer; computer readable program code configured to validate the at least one target farmer input by comparing it to the additional inputs from the plurality of other farmers; computer readable program code configured to generate from the validation, a reliability score for the target farmer by performing at least one of: (i) increasing the reliability score when the at least one target farmer input matches at least a majority of the at least one other farmer inputs and (ii) decreasing the reliability score when the at least one target farmer input does not match at least a majority of the at least one other farmer inputs; and computer readable program code configured to produce from the reliability score, a ranking for the target farmer with respect to the plurality of other farmers.

An additional aspect of the invention provides a computer program product, comprising: computer readable storage medium having computer readable program code embodied therewith and executable by the at least one processor, the computer readable program code comprising: computer readable program code configured to identify a target farmer having a farm producing a crop, wherein the target farmer is located in the same geographical region as a plurality of other farmers each of whom has a farm producing the crop; computer readable program code configured to receive, from the target farmer, at least one target farmer input related to at least one of: (i) a growing condition of the crop corresponding to the farm of the target farmer and (ii) a characteristic of the crop produced by the target farmer; computer readable program code configured to receive, from each of the plurality of other farmers, additional input related to at least one of: (i) a growing condition of the crop corresponding to the farm of the other farmer and (ii) a characteristic of the crop produced by the other farmer; computer readable program code configured to validate the at least one target farmer input by comparing it to the additional inputs from the plurality of other farmers; computer readable program code configured to generate from the validation, a reliability score for the target farmer by performing at least one of: (i) increasing the reliability score when the at least one target farmer input matches at least a majority of the at least one other farmer inputs and (ii) decreasing the reliability score when the at least one target farmer input does not match at least a majority of the at least one other farmer inputs; and computer readable program code configured to produce from the reliability score, a ranking for the target farmer with respect to the plurality of other farmers.

A further aspect of the invention provides a method, comprising: identifying a geographical location comprising a plurality of farmers each having a farm producing a crop; obtaining input from one farmer of the plurality of farmers, wherein the input from said one farmer comprises information corresponding to (i) a characteristic of the land of the farm and (ii) a characteristic of the crop of said one farmer; obtaining other input from each of the remainder of the plurality of farmers, wherein the other input comprises information corresponding to (i) a characteristic of the land of the farm corresponding to the farmer providing the other input and (ii) a characteristic of the crop of the farmer providing the other input; confirming the input received from said one farmer by comparing the information provided by said one farmer to the other input provided by the remainder of the plurality of farmers; creating a reliability score for the one farmer based on the confirming, wherein the reliability score indicates an accuracy of input provided by said one farmer; and creating a ranking for said one farmer based on the reliability score.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a method of producing a ranking for a farmer based upon validating input provided by the farmer using input provided by other farmers within proximity to the farmer and growing the same crop as the farmer.

FIG. 2 illustrates an example overall workflow for producing a ranking for a farmer based upon validating input provided by the farmer using input provided by other farmers within proximity to the farmer and growing the same crop as the farmer.

FIG. 3 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the invention will be best understood by reference to the figures. The following description is intended only by way of example and simply illustrates certain selected exemplary embodiments of the invention as claimed herein. It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

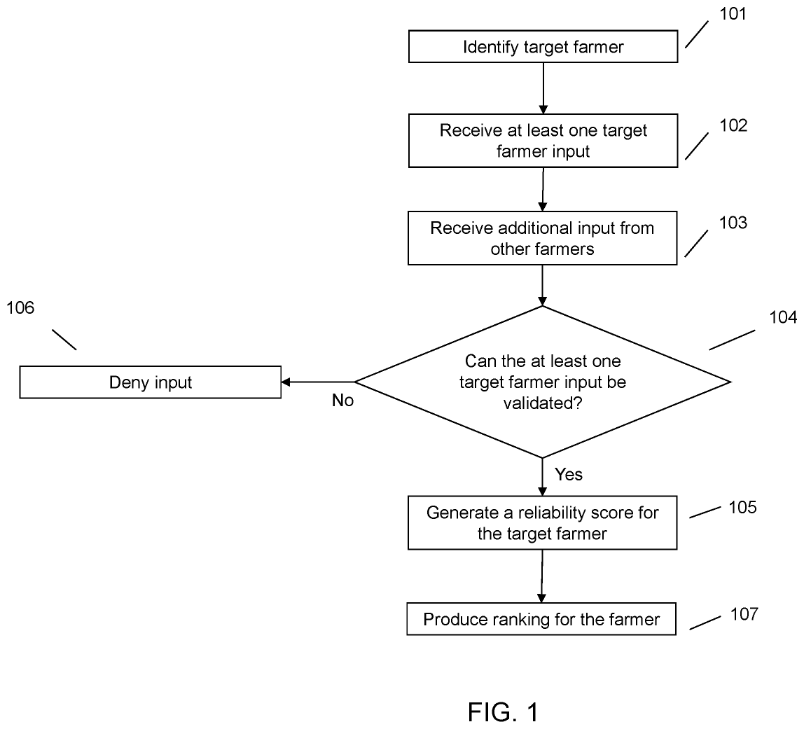

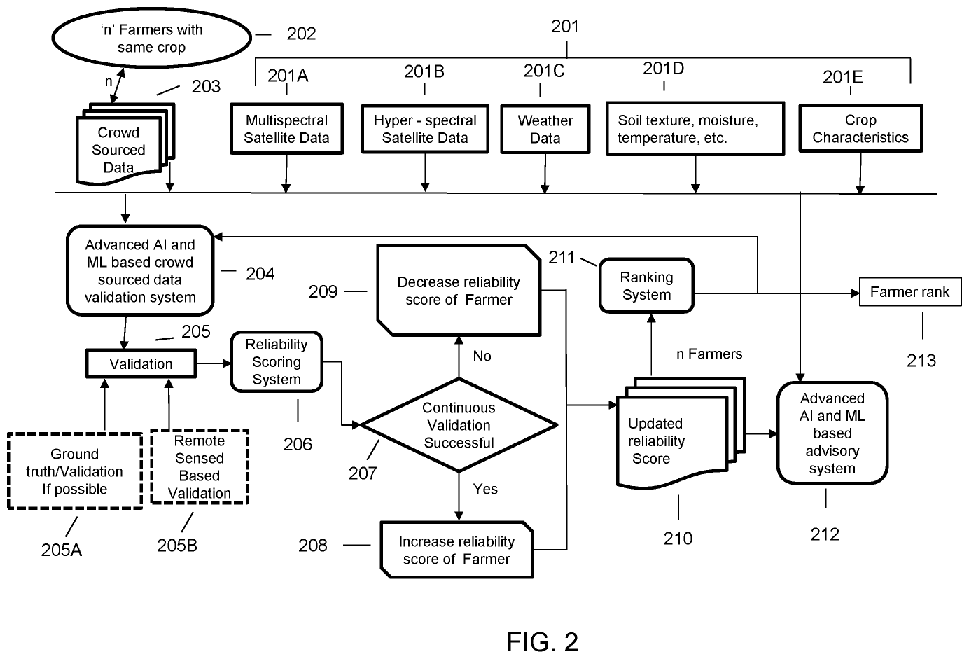

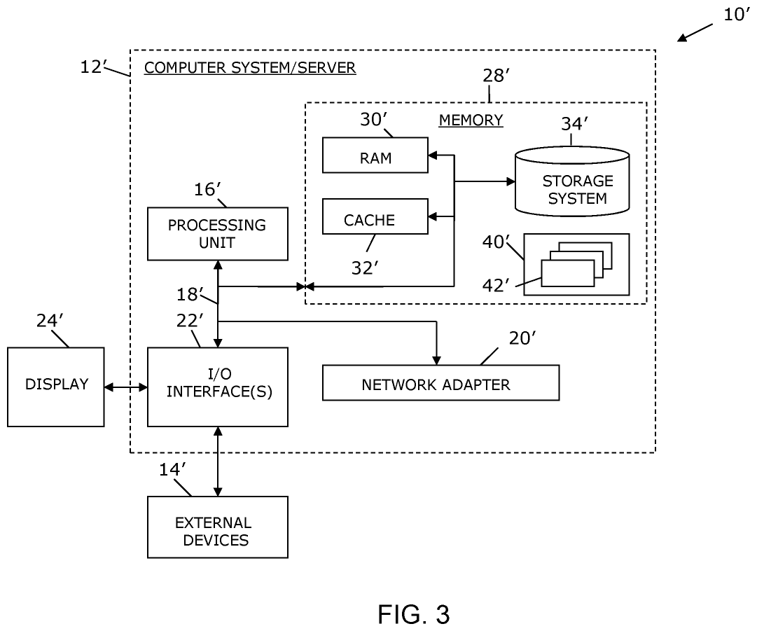

Specific reference will be made here below to FIGS. 1-3. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 3. In accordance with an example embodiment, most if not all of the process steps, components and outputs discussed with respect to FIGS. 1-2 can be performed or utilized by way of a processing unit or units and system memory such as those indicated, respectively, at 16′ and 28′ in FIG. 3, whether on a server computer, a client computer, a node computer in a distributed network, or any combination thereof.

In order to learn additional information about food products, systems have been implemented and made readily available to the public in an attempt to provide missing information to a possible consumer or other stakeholder (e.g., insurance companies, retail stores that purchase the food product for resale, banks, pesticide companies, etc.). For example, vegetation indices such as the Normalized Difference Vegetation Index (NDVI) and red edge, weather data (e.g., rainfall, temperature, humidity), and other auxiliary data (e.g., soil moisture) are used by precision agriculture advisory systems to identify information regarding a crop. For example, the advisory systems may use the information to estimate a crop's health, determine fertilizer grade, determine irrigation standards and schedule, identify or recommend a pesticide schedule during a crop cycle, predict a total yield of a crop, and the like.

The stakeholders rely on this information to make informed decisions regarding the farmer and/or food product. For example, some stakeholders may use the information to extend lines of credit to the farmer, market different pesticides to the farmer, offer lower insurance rates to the farmer, and the like. As another example, some stakeholders may use the information to determine which farmer to purchase the food product from. However, the information provided by the advisory systems may not provide reliable information regarding a specific food product produced by a specific farmer. Additionally, any information that is provided directly by the farmer has no technique for validation. In other words, the stakeholders have to rely on the farmer for providing accurate information even though the farmer has incentive to provide inaccurate information.

Additionally, the agricultural advisory systems are generally directed toward the farmers or producers of the food product in an effort to direct the farmer or other producer in the production or growing of the food product. For example, agricultural indexes may provide farmers with information needed to successfully produce a crop. Vegetation indices like the Normalized Difference Vegetation Index, provide farmers with weather data, such as rainfall data, temperature data, humidity data, and the like. Additionally, other auxiliary data types available to famers, for example, information pertaining to soil moisture, soil makeup, soil mineral content, and the like, may be used by precision agriculture advisory systems to assist a farmer in recommending and identifying crops that will flourish in the area, and how growing conditions make affect crop production.

Since crops generally require certain growing conditions, it is common for neighboring farms in an area to be growing similar, if not the same, crops. For example, while oranges and apples may grow well in California, they do not grow well in the Midwest due to different soil makeups, different weather conditions, and the like. Additionally, since neighboring farms often grow the same crop at similar times (e.g., during different growing seasons that are conducive for the growth of the crop), the growing conditions that the crops are exposed to are generally similar. For example, the soil conditions may be the same, the weather the crops are exposed to are similar, and the like. Thus, information from the farmers within the area can be collected and utilized in generating the advisories. In other words, information pertaining to a crop can be crowd sourced from neighboring farmers and input into agriculture advisory systems, along with the other data already accessible to the advisory system, to generate the farmer information and recommendations. However, currently there is no way to ensure that the information provided by a farmer is accurate. In other words, if the farmer wants to provide inaccurate information regarding the growing conditions of the crop, thereby indicating the crop is better than what the crop actually is, there is no way to determine that the information is inaccurate. Additionally, not only may the farmer's information be inaccurate and misleading to someone who may be looking at the information, but it may also cause the values within the agriculture advisory index to become inaccurate. In other words, the crowd sourced data that are provided are not validated before being utilized.

Accordingly, an embodiment provides a system and method for producing a ranking for a farmer based upon validating input provided by the farmer using input provided by other farmers within proximity to the farmer who are growing the same crop as the farmer. The system can also validate the input provided by the farmer using secondary sources, for example, remote sensed data, local sensed data, interconnected sensor data, weather data, soil data, ground truth data, and the like. This ranking can then be utilized by other systems to provide accurate information regarding a food product. In other words, each piece of information provided by a farmer may be validated, and as a result of the level of accuracy of the information provided by the farmer, a ranking may be produced for each farmer. This ranking provides an indication of how reliable information provided by the farmer is, for example, to stakeholders. The stakeholder is then able to make a more informed decision regarding the farmer or the food product than what is provided in conventional solutions.

To produce the ranking, the system may identify a target farmer producing a crop and neighboring farmers producing the same or similar crop. The system may then receive input from the target farmer regarding either a growing condition of the crop (e.g., a soil makeup, weather information, pesticides used, bug infestation, etc.) or a characteristic of the produced crop (e.g., crop yield, quality of the crop, etc.). The system may also receive similar information from the neighboring farms. Using the input provided by the neighboring farms and input from secondary information sources (e.g., ground truth, satellite, weather data provided by a weather service, remote and local sensor readings, etc.), the system can validate the input provided by the target farmer. A reliability score can then be generated for the target farmer based upon whether the input provided by the farmer matches the validation sources. The reliability score can provide an indication of how accurate the information provided by the farmer is. In other words, the reliability score can provide an indication of how truthful the target farmer is.

From the reliability score the system can provide a ranking of the farmer with respect to the other farmers. In other words, the farmers can be ranked by reliability score into a ranking, with a higher ranked farmer providing more accurate information than a lower ranked farmer. The ranking may, therefore, describe how reliable a farmer is, which may then be made public. Rankings of farmers may be taken into consideration by various other stakeholders, such as insurance companies to offer better premium rates, pesticide companies to offer subsidies, retails stores to decide which farmer to purchase food products from, and the like. Additionally, since the rankings are made public, the rankings provide an incentive to the farmer to provide accurate information, thereby providing more accurate values for agriculture advisory systems. Additionally, crowd sourced information may be weighted by the agriculture advisory systems with farmers having high rankings having a larger influence on the agriculture advisory system values.

Such a system provides a technical improvement over current techniques used to generate agriculture advisory system values. Specifically, unlike conventional systems, the described system and method can validate crowd sourced information before provision into an agriculture advisory system. Additionally, the described system and method can generate a reliability score that can be used to produce a ranking for each farmer. This ranking, which can be made public, may provide stakeholders with information relating to possible business advancement, which may influence how decisions are made with regard to the farmer, which is not possible with the traditional systems. Currently, to the extent that conventional methods accept crowd sourced information, there is no way to validate the information provided by the farmers. Therefore, the farmers can misrepresent information, thereby, skewing the information utilizing the crowd sourced data. Additionally, since there is no ranking system implemented, the farmer does not have any incentive to provide accurate information. Thus, the described systems and method provide a technique that allows for accurately producing agriculture advisory system data by creating a ranking for the farmers based upon accuracy of information and rewarding reliable farmers.

FIG. 1 illustrates a method for producing a ranking for a farmer, based upon validating input provided by the farmer using input provided by other farmers within proximity to the farmer and growing the same crop as the farmer. At 101, a system may identify a target farmer that grows a crop. Among a group of farmers, a target farmer may describe the farmer that the system is currently focused on. In other words, the target farmer may change based upon the desired output of the system. For example, when generating a ranking, the target farmer may be the farmer that the ranking is currently being generated for. Then, when a ranking is generated for a different farmer, that different farmer is now the target farmer.

Many farmers are within an area of neighboring farms that are each growing similar or the same crops. For example, in a particular geographical area, neighboring farmers, or farmers located near the target farmer, may all be growing wheat. It should be understood that “neighboring” does not necessarily mean that the farms are adjacent to each other. Rather, a neighboring farm may be a farm that is in the same geographical region having similar conditions (e.g., weather conditions, soil conditions, etc.) and growing the same or similar crop to the target farmer. In other words, a neighboring farm may be a farm that would be exposed to similar natural conditions in the same geographical region as the target farm.

It should also be noted that the crop does not have to be the identical crop as the target farmer. For example, two farmers may be growing a different strain of wheat, but this may be considered a similar crop. Similarity or “sameness” of the crop may be determined by the responsiveness of the crop to conditions experienced. For example, if one strain of wheat responds differently to pesticides than another strain of wheat, then these strains may not be considered similar enough. In other words, the idea is to reduce the number of variables that could result in different, conflicting information from farmers so that the farmer input can be validated, as discussed further herein.

At 102, the system may receive input from the target farmer. Receiving the input may include obtaining information provided by the farmer directly into an application connected to the system, information provided by the farmer in a secondary source (e.g., social media post, local database of the farmer, etc.), local sensor information of the farmer, or the like. Thus, the system may include the ability to analyze, process, and parse information from either an application of the system, a secondary source, or the like.

The input provided may include information related to one or both of the growing conditions of a crop and a characteristic of a crop. A growing condition may include details pertaining to the geographical area where a crop is grown, any occurrence of pest and disease, natural weather conditions experienced in the area during the growth season, soil conditions (e.g., soil makeup, mineral characteristics, soil moisture level, etc.), pesticides using on the crop, and the like. Characteristics of a crop may include the type of crop being grown, the sowing date of the crop, the crop yield, the crop quality, and the like. The input provided by the target farmer may be information related to or corresponding to the farm of the target farmer.

At 103, the system may receive input from each of or a subset of the other farmers that have been identified as neighboring farmers. In other words, the input received from the other farmers does not have to include input received from each and every one of the neighboring farmers. Additionally, the input provided by each of the other farmers or subset of farmers may not be the same input provided by another of the other farmers. For example, one farmer may provide input related to the soil condition, and another farmer may provide input related to pesticides used during the growing season. As with the target farmer input, the input provided by the other farmers may be provided using any of the techniques described herein. Additionally, as with the target farmer input, the input provided by the other farmers may be related to one or both of a growing condition of the crop and a characteristic of the crop corresponding to the farmer providing the input. In other words, each of the other farmers may provide input related to a growing condition of the crop grown by the farmer providing the input and/or a characteristic of the crop grown by the farmer providing the input. The collection of inputs provided by the other farmers may be considered the “crowdsourced” data with relation to the validation of the target farmer.

In addition to the input received by the target farmer and the other farmers, the system may receive input from secondary sources, including remote-sensed data, ground truth data, local-sensed data, or data from other secondary sources. Secondary sources may utilize technology to measure characteristics of a crop and its growing condition, and may produce an accurate value without the complication of human error. For example, secondary sources of data may include weather data from a weather satellite or weather service, local-sensed data from sensors of the farmer(s) (e.g., sensors for measuring soil moisture level, sensors for detecting pests, etc.), remote-sensed data from geographical sensors (e.g., sensors for measuring wind in an area, sensors for measuring humidity level in an area, sensors for detecting floods in an area, etc.). Thus, secondary sources may collect weather data, multi-spectral and hyper-spectral data, soil moisture data, Normalized Difference Vegetation Index (NDVI) data, and other information that may be similar to or different from the type of information provided by the target farmer and/or other farmers. The information from the secondary sources may be used in validating the crowd sourced data and/or the target farmer input. Technology utilized by a secondary source may include satellites, drones, unmanned aerial vehicles, remote or local sensors, and the like.

The secondary sources may also include a ground truth information source containing ground truth data. The ground truth information source may be considered an information source having completely or highly accurate information. The ground truth information source may be a variable information source where the information included is updated based upon receipt of new accurate information. The information received from secondary sources may be considered more accurate than information provided by either the target farmer or the other farmers.

Responsive to receiving the target farmer input and input from at least one other farmer from the neighboring farmer group, the system may determine if the information provided by the farmer can be validated at 104. To validate the input provided by the target farmer, the system may compare the target farmer input to either or both of the crowd sourced input (i.e., the input received from the other neighbor farmers) and the secondary source input. For example, if the system compares the target farmer input to secondary source input, the system may compare the target farmer input to the ground truth data or the remote sensed based data. As another example, if the system compares the target farmer input to the crowd sourced input, the system may compare the target farmer input corresponding to soil moisture to input provided by another farmer corresponding to soil moisture.

In validating the input the system may weight input sources differently, For example, the secondary sources may be considered more accurate than the crowd sourced information and, therefore, the secondary sources may be weighted higher than the crowd sourced information in validating the target farmer input. The weighting of the input sources may be a default weighting, set by a user, it may be dynamically changed by the system based upon a determined accuracy of the input source, or the like.

Machine learning and artificial intelligence techniques may be utilized by the system to validate information provided by the target farmer. For example, the system may generate a machine learning (ML) or artificial intelligence (AI) model for validating the target farmer input. The ML and/or AI model(s) may be generated from the crowd sourced information and then compared against the ground truth and/or remote sensed data. The ML or AI model(s) may be generated for all possible inputs, for each possible input, or a combination of inputs. In other words, one or more ML or AI models may be generated. These models learn what information is accurate based upon the comparison of the information within the models to the highly or completely accurate ground truth or other secondary source information that is considered highly or completely accurate. Additionally, a subject matter expert or other user may rate the sources of information as accurate/inaccurate or on a rating scale, and the models may additionally, or alternatively, use these ratings to learn what information should be considered accurate. In other words, user input may be provided to the models and used by the models to learn information regarding different information sources. As the model learns what information is considered accurate, it can validate new information as it comes into the model. The models are continuously updated as more data may be provided by the sources. Thus, the models may be based upon input received over time.

In an embodiment, if the target farmer input cannot be validated at 104, the target farmer input may be denied at 106. This denial may result in the target farmer input being excluded from calculations of data for the agriculture advisory systems. The inability to validate the information means that the system is unable to come to a conclusion regarding the accuracy of the input. In other words, even if the system determines that the target farmer input is inaccurate, this is still considered a validation of the target farmer input. If, however, the target farmer input can be validated at 104, the system may generate a reliability score for the target farmer at 105. The reliability score can be generated for the farmer regardless of the accuracy of the target farmer input. In other words, the reliability score may decrease if the accuracy of the information is determined to be inaccurate or less than accurate, and it may increase if the information is determined to be accurate.

A reliability score for a farmer may be associated with the accuracy of the information provided. In other words, the reliability score provides an indication of how accurate the information provided by the target farmer is. The system may first calculate an initial reliability score for each farmer. The initial reliability score may be updated over time as input is provided by a farmer. When the information provided by a target farmer matches the information provided by the other farmers and/or the secondary sources, the reliability score of the farmer may increase. When the information provided by the target farmer does not match the information provided by the other farmers and/or the secondary sources, the reliability score of the farmer may decrease. Matching or not matching the information of the other sources may be based upon matching or not matching a majority of the input provided by other sources. For example, if the information provided by the farmer matches a majority of the other farmers but not all the other farmers, then it may be considered accurate, thereby increasing the reliability score.

The other farmer input may be weighted based upon a reliability score of the other farmer. For example, if the other farmer has a low reliability score and the input of the target farmer does not match, then this may actually cause the target farmer reliability score to increase, since it can be inferred that the other farmer having a low reliability score is probably providing inaccurate information, thereby making the target farmer input accurate. On the other hand, if the target farmer input does not match a farmer having a high reliability score, then the target farmer reliability score may decrease since it can be inferred that the input provided by the other farmer is accurate, thereby making the target farmer input inaccurate. As another example, if the target farmer input matches a farmer having a mid-level reliability score, the reliability score of the target farmer may not change because it is not known whether the target farmer input is accurate or inaccurate.

An amount of change in the reliability score may be based upon a determined accuracy of the matching source. For example, if a secondary source is weighted higher than a crowd sourced source, then the target farmer input matching the secondary source may cause a higher increase in the reliability score than if it matches the crowd sourced source. Similarly, the amount of change in the reliability score may be based upon the weighting of the other farmer input that was matched with the target farmer input. The reliability score for a farmer may be continuously updated based on validations of the target farmer input. In other words, the reliability score may be continuously updated as input is provided by the target farmer. Additionally, as input is received by a farmer having a reliability score over a predetermined threshold, either a default threshold or set by the user, the system may update the ground truth data with the input provided by the farmer. If that same farmer's reliability score decreases below the predetermined threshold, it may no longer be used to update the ground truth data. On the other hand, if a farmer having a reliability score below the predetermined threshold raises his/her reliability score above the threshold, that farmer's input may now be used to update the ground truth data.

Once the reliability score is generated, the system may produce a ranking for the target farmer with respect to the neighbor farms at 107. To generate the ranking the system may simply rank the farmers based upon the reliability score, with the farmer having the highest reliability score having the highest ranking and the farmer having the lowest reliability score having the lowest ranking. Thus, the system may generate a ranking for each of the farmers, generate an overall ranking list, and provide the overall ranking to each of the farmers within the group (i.e., the neighbor farmers and the target farmer). In other words, the overall ranking is accessible to all the farmers within the group.

Providing the overall ranking may include providing the rankings within an application accessible by the farmer(s). Additionally, along with the target farmer's personal score, anonymous scores of the neighboring farmers may also be available to the target farmer. Alternatively, the scores may be made public and not anonymous. The ranking may be generated to motivate farmers to provide honest information. Mechanisms may be adopted to promote providing truthful and accurate information. For example, one mechanism may include (i) correlating the reliability score and the success of an advisory system, (ii) showing this correlation for all the neighbor farmers, and (iii) providing a monetary award to a farmer for providing accurate information, which may then be made public. The ranking of each farmer may encourage honest information regarding growing conditions of a crop and characteristics of the crop, which may ultimately impact the accuracy of the values produced and referenced in agriculture advisory systems and used by other stakeholders. For example, if the rankings are made public, retail stores can determine which farmers to purchase products from, insurance brokers can determine which farmers to provide incentives to, bankers can determine which farmers to provide loans to, and the like.

As a brief overview, referring now to FIG. 2, a system may receive a plurality of inputs 201 provided by secondary sources, the target farmer, or neighbor farmers. Inputs may include, for example, multispectral satellite data 201A, hyper-spectral satellite data 201B, weather data 201C, crop growing condition data (soil texture, moisture, temperature, etc.) 201D, crop characteristics 201E, and the like. The system may receive crowd sourced data 203 provided by each of a number of farmers that are considered neighbors or located near the target farmer 202. The information 201 and 203 may be received by advanced artificial intelligence and machine learning models 204 which may validate the information provided by a target farmer or determine if the information provided by a target farmer is accurate.

The validation 205 may also include validating information provided by the farmer using ground truth data 205A and remote sensed based data 205B, if this information is available. The result of the validation may be sent to a reliability scoring system 206. At 207 a decision may be made classifying the received farmer information as accurate (successful) or not accurate (not successful). When the information validation is unsuccessful, the reliability score of the farmer may decrease at 209. When the information validation is successful, the reliability score may increase at 208. The reliability score may be updated at 210 based upon whether the validation identified the input as accurate or not accurate. As mentioned previously, a reliability score may be continuously updated as a farmer provides input into the system. The updated reliability score may be used for producing the ranking of a farmer at 211 with respect to the other farmers. The ranking system 211 may determine where a farmer may rank in comparison to the farmers within the group. The updated reliability score may also be provided to an advanced artificial intelligence and machine learning based advisory system 212. The farmer ranking may be output at 213.

Thus, the described systems and methods represent a technical improvement over current systems for generating agriculture advisory system value calculations and providing information regarding food products, by providing a system that can validate information provided by a target farmer. Based upon the validation, a reliability score can be generated or updated and a ranking can be produced based upon the reliability score for the target farmer. This ranking may lead to successful cultivation, accurate information within advisories, and further business opportunities for farmers, thereby providing an incentive to the farmers to provide accurate information. Currently conventional systems cannot validate the target farmer input, nor can the conventional systems generate rankings for farmers. Rather, conventional techniques rely on farmers accurately providing information for a system and accepting whatever information is provided. Thus, the described system and methods allows for a technique of validating the information input by a farmer so that information utilized by other stakeholders (e.g., agriculture advisory systems, insurance brokers, retail stores, etc.) can be as accurate as possible.

As shown in FIG. 3, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12′; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, comprising;
identifying a target farmer having a farm producing a crop, wherein the target farmer is located in the same geographical region as a plurality of other farmers each of whom has a farm producing the crop;
receiving, from the target farmer, at least one target farmer input related to at least one of: (i) a growing condition of the crop corresponding to the farm of the target farmer and (ii) a characteristic of the crop produced by the target farmer;
receiving, from each of the plurality of other farmers, additional input related to at least one of: (i) a growing condition of the crop corresponding to the farm of the other farmer and (ii) a characteristic of the crop produced by the other farmer;
validating the at least one target farmer input by comparing it to the additional inputs from the plurality of other farmers;
generating, from the validation, a reliability score for the target farmer by performing at least one of: (i) increasing the reliability score when the at least one target farmer input matches at least a majority of the at least one other farmer inputs and (ii) decreasing the reliability score when the at least one target farmer input does not match at least a majority of the at least one other farmer inputs; and
producing, from the reliability score, a ranking for the target farmer with respect to the plurality of other farmers.

2. The method of claim 1, comprising receiving at least one input from a secondary source related to a (i) growing condition of the crop corresponding to the farm of the target farmer and (ii) a characteristic of the crop produced by the target farmer.

3. The method of claim 2, wherein the validating comprises comparing the at least one target farmer input to the at least one input received from a secondary source.

4. The method of claim 2, wherein the at least one input from a secondary source comprises at least one input selected from the group consisting of: weather data, multi-spectral data, hyper-spectral data, soil moisture data, Normalized Difference Vegetation Index data, remote sensed data, and local sensed data.

5. The method of claim 1, wherein the reliability score for the target farmer is continually updated based upon inputs (i) received from and (ii) validated for the target farmer.

6. The method of claim 1, wherein the validating comprises comparing the at least one target farmer input to (i) ground truth data and (ii) remote sensed based data.

7. The method of claim 6, comprising updating the ground truth data with the at least one target farmer input if the target farmer has a reliability score greater than a predetermined threshold.

8. The method of claim 1, comprising producing a ranking for each of the plurality of other farmers with respect to (i) the other farmers of the plurality of farmers and (ii) the target farmer.

9. The method of claim 8, comprising providing an overall ranking for the plurality of farmers and the target farmer to (i) each of the plurality of farmers and (ii) the target farmer.

10. The method of claim 1, wherein the validation comprises (i) generating a machine-learning model from the at least one target farmer inputs and the at least one other farmer inputs received over time and (ii) using the machine-learning model to perform the validation.

11. An apparatus, comprising:
at least one processor; and
computer readable storage medium having computer readable program code embodied therewith and executable by the at least one processor, the computer readable program code comprising:
computer readable program code configured to identify a target farmer having a farm producing a crop, wherein the target farmer is located in the same geographical region as a plurality of other farmers each of whom has a farm producing the crop;
computer readable program code configured to receive, from the target farmer, at least one target farmer input related to at least one of: (i) a growing condition of the crop corresponding to the farm of the target farmer and (ii) a characteristic of the crop produced by the target farmer;
computer readable program code configured to receive, from each of the plurality of other farmers, additional input related to at least one of: (i) a growing condition of the crop corresponding to the farm of the other farmer and (ii) a characteristic of the crop produced by the other farmer;
computer readable program code configured to validate the at least one target farmer input by comparing it to the additional inputs from the plurality of other farmers;
computer readable program code configured to generate from the validation, a reliability score for the target farmer by performing at least one of: (i) increasing the reliability score when the at least one target farmer input matches at least a majority of the at least one other farmer inputs and (ii) decreasing the reliability score when the at least one target farmer input does not match at least a majority of the at least one other farmer inputs; and
computer readable program code configured to produce from the reliability score, a ranking for the target farmer with respect to the plurality of other farmers.

12. A computer program product, comprising:
computer readable storage medium having computer readable program code embodied therewith and executable by the at least one processor, the computer readable program code comprising:
computer readable program code configured to identify a target farmer having a farm producing a crop, wherein the target farmer is located in the same geographical region as a plurality of other farmers each of whom has a farm producing the crop;
computer readable program code configured to receive, from the target farmer, at least one target farmer input related to at least one of: (i) a growing condition of the crop corresponding to the farm of the target farmer and (ii) a characteristic of the crop produced by the target farmer;
computer readable program code configured to receive, from each of the plurality of other farmers, additional input related to at least one of: (i) a growing condition of the crop corresponding to the farm of the other farmer and (ii) a characteristic of the crop produced by the other farmer;
computer readable program code configured to validate the at least one target farmer input by comparing it to the additional inputs from the plurality of other farmers;
computer readable program code configured to generate from the validation, a reliability score for the target farmer by performing at least one of: (i) increasing the reliability score when the at least one target farmer input matches at least a majority of the at least one other farmer inputs and (ii) decreasing the reliability score when the at least one target farmer input does not match at least a majority of the at least one other farmer inputs; and
computer readable program code configured to produce from the reliability score, a ranking for the target farmer with respect to the plurality of other farmers.

13. The computer program product of claim 12, comprising receiving at least one input from a secondary source related to (i) a growing condition of the crop corresponding to the farm of the target farmer and (ii) a characteristic of the crop produced by the target farmer.

14. The computer product of claim 13, wherein the validating comprises comparing the at least one target farmer input to the at least one input received from a secondary source.

15. The computer product of claim 12, wherein the reliability score for the target farmer is continually updated based upon inputs (i) received from and (ii) validated for the target farmer.

16. The computer product of claim 12, wherein the validating comprises comparing the at least one target farmer input to (i) ground truth data and (ii) remote sensed based data.

17. The computer product of claim 16, comprising updating the ground truth data with the at least one target farmer input if the target farmer has a reliability score greater than a predetermined threshold.

18. The computer product of claim 12, comprising producing a ranking for each of the plurality of other farmers with respect to (i) the other farmers of the plurality of farmers and (ii) the target farmer.

19. The computer product of claim 12, wherein the validation comprises (i) generating a machine-learning model from the at least one target farmer inputs and the at least one other farmer inputs received over time and (ii) using the machine-learning model to perform the validation.

20. A method, comprising;
identifying a geographical location comprising a plurality of farmers each having a farm producing a crop;
obtaining input from one farmer of the plurality of farmers, wherein the input from said one farmer comprises information corresponding to (i) a characteristic of the land of the farm and (ii) a characteristic of the crop of said one farmer;
obtaining other input from each of the remainder of the plurality of farmers, wherein the other input comprises information corresponding to (i) a characteristic of the land of the farm corresponding to the farmer providing the other input and (ii) a characteristic of the crop of the farmer providing the other input;
confirming the input received from said one farmer by comparing the information provided by said one farmer to the other input provided by the remainder of the plurality of farmers;
creating a reliability score for said one farmer based on the confirming, wherein the reliability score indicates an accuracy of input provided by said one farmer; and
creating a ranking for said one farmer based on the reliability score.
